(19) United States
(12) Patent Application Publication
(10) Pub. No.: US 2025/0150444 A1
(43) Pub. Date: May 8, 2025

(54) SYSTEMS AND METHODS FOR ONGOING MULTIFACTOR AUTHENTICATION

(71) Applicant: CABLE TELEVISION LABORATORIES, INC., Louisville, CO (US)

(72) Inventors: JASON W. RUPE, Lafayette, CO (US); BRIAN A. SCRIBER, Lafayette, CO (US); KYLE HAEFNER, Erie, CO (US); MASSIMILIANO PALA, Denver, CO (US); SIMON KRAUSS, Denver, CO (US)

(21) Appl. No.: 18/941,026

(22) Filed: Nov. 8, 2024

Related U.S. Application Data
(60) Provisional application No. 63/547,789, filed on Nov. 8, 2023.

(51) Int. Cl. H04L 9/40

(52) U.S. Cl. CPC H04L 63/08

(57) ABSTRACT

A system for ongoing multifactor authentication is provided. The system includes a computer device including at least one processor in communication with at least one memory device. The at least one memory device includes computer instructions that cause the at least one processor to a) instruct a computer device to conduct a multifactor authentication of a user; calculate an authentication level for the user based upon the multifactor authentication of the user; b) continually monitor one or more actions of the user to determine additional authentication data; c) update the authentication level for the user based upon the additional authentication data; d) receive a request from the user to access a first content; e) access an authentication profile for the first content; f) compare the authentication profile to the updated authentication level for the user; and g) determine whether to grant access to the first content based upon the comparison.

### CROSS REFERENCE TO RELATED APPLICATIONS

This application claims priority to U.S. Provisional Application No. 63/547,789, filed Nov. 8, 2023, which is hereby incorporated by reference in its entirety.

### BACKGROUND

The field of the invention relates generally to ongoing multifactor authentication, and more specifically, to systems and methods of verifying and validating users and content via ongoing multifactor authentication.

When two or more parties need to securely communicate, they need to have a mechanism that allow them to trust the credentials provided by the other party. Furthermore, there are many tools that allow malicious parties to pose as others. Emails, messages, video conferences, documents, and other content may be faked and/or modified by unauthorized individuals. Furthermore, unauthorized individuals may gain access to secure content. Accordingly, it would be useful to have a system to validate that provided content is from who it alleges and to verify that users are who they allege to be.

### BRIEF DESCRIPTION

A system for ongoing multifactor authentication is provided. The system includes at least one computer device including at least one processor in communication with at least one memory device. The at least one memory device includes computer instructions that cause the at least one processor to instruct a computer device to conduct a multifactor authentication of a user. The computer instructions also cause the at least one processor to calculate an authentication level for the user based upon the multifactor authentication of the user. The computer instructions further cause the at least one processor to continually monitor one or more actions of the user to determine additional authentication data. In addition, the computer instructions cause the at least one processor to update the authentication level for the user based upon the additional authentication data. Moreover, the computer instructions cause the at least one processor to receive a request from the user to access a first content. Furthermore, the computer instructions cause the at least one processor to access an authentication profile for the first content. Additionally, the computer instructions cause the at least one processor to compare the authentication profile to the updated authentication level for the user. In addition, the computer instructions also cause the at least one processor to determine whether to grant access to the first content based upon the comparison. The system may include additional, less, or alternate functionality, including that discussed elsewhere herein.

A system for ongoing multifactor authentication is provided. The system includes at least one computer device including at least one processor in communication with at least one memory device. The at least one memory device includes computer instructions that cause the at least one processor to instruct a computer device to conduct a multifactor authentication of a user. The computer instructions also cause the at least one processor to calculate an authentication level for the user based upon the multifactor authentication of the user. The computer instructions further cause the at least one processor to continually monitor one or more actions of the user to determine additional authentication data. In addition, the computer instructions cause the at least one processor to update the authentication level for the user based upon the additional authentication data. Moreover, the computer instructions cause the at least one processor to receive a first content item from the user. Furthermore, the instructions cause the at least one processor to generate a security signature for the first content item based upon the updated authentication level for the user. Additionally, the instructions cause the at least one processor to add the security signature to the first content item. The system may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary architecture for a verification and validation (VV) system, in accordance with at least one embodiment.

FIG. 2 illustrates an exemplary process for continuously authenticating a user using the VV system 100 shown in FIG. 1.

FIG. 3 illustrates an exemplary process for authenticating content using the VV system 100 shown in FIG. 1.

FIG. 4 illustrates an exemplary process for verifying a user to access content using the VV system shown in FIG. 1.

FIG. 5 illustrates and exemplary process for verifying and validating users to connect to each other using the VV system shown in FIG. 1.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

The present embodiments may relate to, inter alia, systems and methods for verifying and validating users and content via ongoing multifactor authentication. In one example embodiment, the methods may be performed by verification and validation computer device. The present embodiments relate to authenticating using a plurality of authentication methods and then confirming the authentication through addition information, connections, and/or actions of the user. The present embodiments, also include adding the authentication of the user to content that the user creates. Other embodiments include limiting the user's access to content based upon the user's authentication level and the authentication levels of the corresponding content.

Furthermore, the present disclosure describes systems and methods for providing continual authentication for a user. This allows the user to be authenticated via an active multi-factor authentication. Then the system monitors the behavior of the user to maintain and update that authentication.

In a first use case, a user creates content. The content is created to share the content online or as a message to a single person or small group through any web application. Initially, the user initiates the engagement by authenticating via a combination of factors, including, but not limited to, two factor authentication with password, facial recognition, fingerprint recognition, facial movement in pattern directed by a second factor, second party confirmation and witness, and/or any other desired factor.

The application authenticates the user and executes. The user begins creating the content, such as message content. The system constantly monitors the identity of the user through techniques, such as, but not limited to, facial recognition, fingerprint recognition (from typing if possible), and reauthenticating of the final content. Each element of the content is given an authentication score (or authentication level) by the level of authentication used in the initiation, during the creation, and the confirmation of the content. The elements of content include, but are not limited to, individual pages, changes, chapter or other divisions of the whole content, metadata, and/or other portions of the content. The authentication score (or level) is appended to the content as metadata, and encrypted, such as with the user's private key. For example, a hash is created which is posted on a third party site for confirmation. The hash is sent encrypted through a privacy app or other similar technique.

In a second use case, a user consumes created content. The created content may have a policy set for a user to be able to access the content. If so, the content may want the user to be authenticated in way like above before being allowed to consume/access the content. In these situations, the system authenticates the user if required to by the content policy. In some of these embodiments, the system filters content as per the policy and/or session requests. The content may be filtered to not show content that the user is not authenticated enough to consume/access. The user then selects the content that they wish to consume/access. The system confirms/verifies that the user is authenticated, such as by comparing the user's authentication score/level to the requirements of the content. The system may also confirm the content validity. If all the verifications pass, the system allows the user access to the content. In some embodiments, the system provides the validation information for the content to the user. This system provides for the local archival of content as required and requested by policies, with retained tamper proof capabilities.

In a third use case, the system provides real time two or multi-way communication. Each user is authenticated using the continuous authentication as described herein. An authentication score/level is determined for each user. The communication application is initiated on each end for each user. Each user's authentication score/level is provided to all other users and their applications. Each user confirms their trust in the authentication score/level given, or requests further authentication. Note that out of band confirmation is possible. Each user has a policy describing the requirements of authentication for other that they require for connection to those others. Each user has the choice to accept a lower authentication score/level than their policy is set to, lower their policy, request further authentication, etc., in order to proceed.

Once a user accepts another user and are accepted by that first party, their connection can be established, or held off depending on desired application behavior. The next user to join then must accept the other two and the other two must accept that user for the three way join to happen, and so on.

As in the first use case, the multiple factors are used to update the authentication score/level frequently and in real-time. In some embodiments, the system displays an indicator for each user on each receiver end. User policy can also be set to block send to a user whose score drops below a policy threshold or other rule structure. Users can also adjust their interactions accordingly, or drop the connection. Also, each communication can have a policy requirement for authentication score/level in order to be maintained. The policy may be enforced to drop the connections for the party in violation or for the entire call. For example, on a video call, if someone walks away from the camera and facial recognition is a required factor for the authentication score/level for the conversation or a party on the conversation, the feed to and from the user who walked away can be stopped. This essentially puts them on hold or forces them to drop and reestablish. Likewise, user whose policy is violated by that user walking away, even though the communication policy may not be as strict, may block their send and-or receive from that user. Users may drop the communication as they please as well. Users who join later start at the beginning of this process, and are accepted or rejected by others as described above.

At least one of the technical solutions to the technical problems provided by this system may include: (i) improved document security; (ii) improve authentication of documents and users; (iii) maintaining authentication in real-time; (iv) improved security for documents and communications; and/or (v) improved security for real-time communications.

The methods and systems described herein may be implemented using computer programming or engineering techniques including computer software, firmware, hardware, or any combination or subset thereof, wherein the technical effects may be achieved by performing at least one of the following steps: a) instruct a computer device to conduct a multifactor authentication of a user; b) calculate an authentication level for the user based upon the multifactor authentication of the user; c) continually monitor one or more actions of the user to determine additional authentication data; d) update the authentication level for the user based upon the additional authentication data; e) receive a request from the user to access a first content; f) access an authentication profile for the first content; g) compare the authentication profile to the updated authentication level for the user; h) determine whether to grant access to the first content based upon the comparison; i) retrieve an authentication level associated with the first content; j) validate the first content based upon the authentication level associated with the first content; k) wherein the first content includes a security signature for a creator of the first content; l) wherein the security signature includes an identifier for the creator of the first content and an authentication level for the creator of the first content during creation of the first content; m) wherein the security signature includes a hash of the first content and the authentication level for the creator of the first content; n) retrieve a copy of the hash from a third-party server; o) compare the copy of the hash from the third-party server to the hash from the security signature to validate the first content; p) wherein the first content is encrypted; q) wherein the first content is locked from being changed; r) wherein the authentication profile includes a required authentication level to be able to access the first content; s) determine that the updated authentication level for the user is insufficient for the authentication profile; t) request one or more additional authentication activities from the user to access the first content; u) receive a listing of a plurality of content items, wherein each content item includes a required authentication level to access; v) compare the updated authentication level of the user the plurality of required authentication levels to access; w) filter and display at least a portion of the plurality of content items based upon the comparison; x) prevent display of content items of the plurality of content items that the updated authentication level is insufficient to access; y) display an indicator of the required authentication level for each displayed content item listing, and z) wherein the request from the user to access a first content is from a user selection of the first content from the plurality of content items.

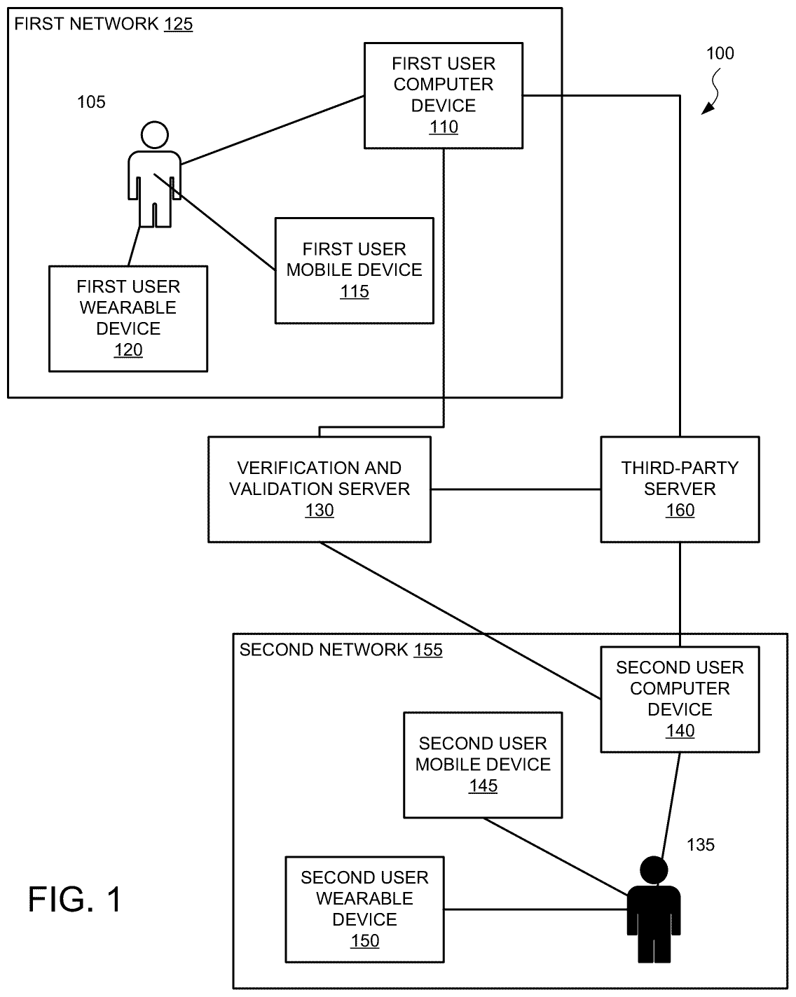

FIG. 1 illustrates an exemplary architecture for a verification and validation (VV) system 100, in accordance with at least one embodiment. In an example embodiment, the VV system 100 performs authentication for a first user 105 and a second user 135. The first user 105 may have access to one or more first user computer devices 110, one or more first user mobile devices 115, and/or one or more first user wearable devices 120. In the example embodiment, one or more of the first user computer device 110, the first user mobile device 115 and the first user wearable device 120 are connected to a first network 125.

The second user 135 may have access to one or more second user computer devices 140, one or more second user mobile devices 145, and/or one or more second user wearable devices 150. In the example embodiment, one or more of the second user computer device 140, the second user mobile device 145 and the second user wearable device 150 are connected to a second network 155. The first network 125 and the second network 155 includes the Internet, a local area network (LAN), a wide area network (WAN), or any other type of network that allows the systems and methods described herein.

First user computer devices 110 and second user computer devices 140 include computers or computing devices that include a web browser or a software application, which enables first user computer devices 110 and second user computer devices 140 to communication with other devices, such as, but not limited to, first user mobile devices 115, first user wearable devices 120, second user mobile devices 145, and second user wearable devices 150 using the Internet, a LAN, a WAN, a Bluetooth connection, and a Near Field Communication (NFC) connection. In some embodiments, the user computer devices 110 and second user computer devices 140 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. First user computer devices 110 and second user computer devices 140 may be any computer device capable of accessing a network, such as the Internet, including, for example a desktop computer and a laptop computer.

First user mobile devices 115 and second user mobile devices 145 include computers or computing devices that include a web browser or a software application, which enables first user mobile devices 115 and second user mobile devices 145 to communication with other devices, such as, but not limited to, first user computer devices 110, first user wearable devices 120, second user computer devices 140, and second user wearable devices 150 using the Internet, a LAN, a WAN, a Bluetooth connection, and a NFC connection. In some embodiments, the first user mobile devices 115 and second user mobile devices 145 are communicatively coupled to the Internet through many interfaces including, but not limited to, at least one of a network, such as the Internet, a LAN, a WAN, or an ISDN, a dial-up-connection, a DSL, a cellular phone connection, a satellite connection, and a cable modem. First user mobile devices 115 and second user mobile devices 145 may be any mobile computer device capable of accessing a network, such as the Internet, including, for example a laptop computer, a PDA, a cellular phone, a smartphone, a tablet, a phablet, or other web-based connectable equipment or mobile devices.

First user wearable devices 120 and second user wearable devices 150 include computers or computing devices that include a web browser or a software application, which enables first user wearable devices 120 and second user wearable devices 150 to communication with other devices, such as, but not limited to, first user computer devices 110, first user mobile devices 115, second user computer devices 140, and second user mobile devices 145 using the Internet, a LAN, a WAN, a Bluetooth connection, and a NFC connection. In some embodiments, the first user wearable devices 120 and second user wearable devices 150 are communicatively coupled to the Internet through many interfaces including, but not limited to, at least one of a network, such as the Internet, a LAN, a WAN, or an ISDN, a dial-up-connection, a DSL, a cellular phone connection, a satellite connection, and a cable modem. First user wearable devices 120 and second user wearable devices 150 may be any computer device capable of accessing a network, such as the Internet, including, for example wearable electronics, smart watch, virtual headsets or glasses (e.g., AR (augmented reality), VR (virtual reality), MR (mixed reality), or XR (extended reality) headsets or glasses), or other web-based connectable equipment or mobile devices.

In the example embodiment, the VV system 100 includes one or more verification and validation servers (VV) 130 (also known as VV computer devices 130). The VV servers 130 may be computers or computing devices that include a web browser or a software application, which enables VV servers 130 to communicate with computer devices, such as first user computer device 110 and second user computer devices 140, using the Internet, a LAN, or a WAN. In some embodiments, the VV servers 130 are communicatively coupled to the Internet through many interfaces including, but not limited to, at least one of a network, such as the Internet, a LAN, a WAN, or an ISDN, a dial-up-connection, a DSL, a cellular phone connection, a satellite connection, and a cable modem. VV servers 130 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In some embodiments, VV servers 130 may be in communication with a computer program or application executing on one of the first user computer device 110, first user mobile device 115, second user computer user device 140, and second mobile device 145.

Furthermore, the computer devices 110 and 140 and the VV server 130 are in communication with one or more third-party servers 160. The third-party servers 160 provide secure storage and access to information. In some embodiments, the third-party servers 160 are associated with distributed ledgers, aka blockchain, to allow for secure and immutable access to the information stored in the third-party servers 160.

While the disclosed systems and methods describe a first user 105 and a second user 135, one having skill in the art would understand that these systems and methods may used with large pluralities of user.

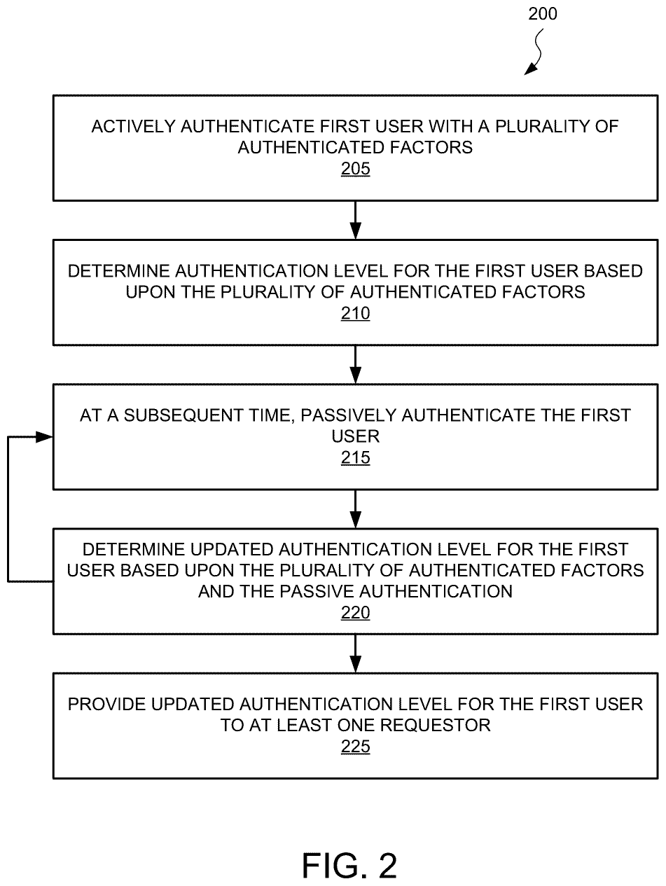

FIG. 2 illustrates an exemplary process 200 for continuously authenticating a user using the VV system 100 (shown in FIG. 1). In the example embodiment, the steps of process 200 are performed by the VV server 130 (shown in FIG. 1).

In the example embodiment, the VV server 130 actively authenticates 205 the first user 105 (shown in FIG. 1) with a plurality of authentication factors. The plurality of authentication factors include, but are not limited to, knowledge-based factors, possession-based factors, inherence-based factors, location-based factors, and/or behavior-based factors. The knowledge-based factors include, but are not limited to, username/password and personal identification number (PIN). The possession-based factors include, but are not limited to, device identifiers, hardware token, and/or one-time codes sent via email or short message service (SMS). Inherence-based factors include biometric authentication, such as, but not limited to, voice recognition, facial recognition, retina scans, iris scans, fingerprint scans, and/or palmprint or handprint scans. The plurality of location-based factors include geolocation, such as via GPS (Global Positioning Systems), cellular or wireless triangulation, or by determining locations with connected networks 125 and 155 (both shown in FIG. 1). The plurality of behavior-based factors includes performing behaviors within a defined interface and also include analyzing user behavior to recognize patterns associated with the user. Further examples of behaviors include the first user 105 having two or more of their first user computer device 110, first user mobile device 115, and first user wearable device 120 with the first user 105 and within communication range with each other, such as via Bluetooth.

In the example embodiment, the VV server 130 actively authenticates 205 the first user 105 via the first user computer device 110, the first user mobile device 110, and/or the first user wearable device 115. For example, one authentication factor may be a connection between the first user mobile device 110 and the first user wearable device 115. In this example, the first user mobile device 110 is the first user's smartphone, which is in a Bluetooth connection with the first user wearable device 115, which is a smartwatch. Another authentication factor is that both the first user computer device 110 (the user's laptop) and the first user mobile device 115 (the user's smartphone) have been logged into, aka authenticated within a specific period of time. Another factor is then that both the first user computer device 110 (the user's laptop) and the first user mobile device 115 (the user's smartphone) are logged into the same network 125. In some embodiments, the VV server 130 and the first user's devices 110, 115, and 120 perform multifactor authentication simultaneously. For example, the first user's devices 110, 115, and 120 may be configured to capture biometric information while the first user 105 is entering their password or PIN. This may be by simultaneously performing facial recognition and/or fingerprint recognition.

In some further embodiments, authentication may be provided by one or more second parties that are already authenticated that are attesting to and/or witness to the identity of the first user 105.

In the example embodiment, the VV server 130 determines 210 an authentication level for the first user 105 based upon the plurality of authenticated factors. In some embodiments, the authentication level is based upon the number of successful authentications. In other embodiments, the authentication level depends on which authentications were successful, where some authentication types are more important or ranked higher than others. In some embodiments, the authentication level is a score. In other embodiments, the authentication is a listing of successful authentications.

In the example embodiment, at a subsequent point in time, the VV server 130 passively authenticates 215 the first user 105. In some embodiments, the VV server 130 passively authenticates 215 the first user 105 via at least one of the first user computer device 110, the first user mobile device 115, and the first user wearable device 120. These passive identifications include, but are not limited to, facial recognition, fingerprint recognition (e.g., from typing on a phone or tablet), location data, heartbeat monitoring (such as via a smart watch or other monitor), breathing monitoring (such as via headset or ear-based microphones), typing patterns, monitoring of proximity of other known devices, connected networks 125, and/or other passively collected authentication data. In these embodiments, the VV server 130 has collected historical authentication data about the first user 105 and uses that data to generate one or more models of behavior for the first user 105. During the passive authentication, the VV server 130 compares those one or more models to the actual behavior of the first user 105.

One example of behavior may be that the first user usually works from home and leaves their tablet on the dinning room table while the go upstairs to work on their personal computer. The VV server 130 then recognizes that the tablet is connected to the same WI-FI network 125 as the personal computer, but is not in Bluetooth range of the personal computer, the smartphone, and/or the first user's smart watch.

In the example embodiment, the VV server 130 determines 220 an updated authentication level for the first user 105 based upon the plurality of authenticated factors and the passive authentication. In the example embodiment, the VV server 130 performs continuous multifactor authentication or validation on the user's identity. In this embodiment, the VV server 130 repeatedly performs steps 215 and 220 of process 200 to continually update the authentication level for the first user 105.

In the example embodiment, the VV server 130 provides 225 the updated authentication level for the first user 105 to at least one requestor. The VV server 130 provides 225 the updated authentication level upon request, to programs, to devices, to services, and/or any other authorized requestor. In the example embodiment, the requestor is validated before providing 225 the updated authentication level.

In some embodiments, the VV server 130 stores authentication data in one or more databases. In some further embodiments, the VV server 130 stores the authentication data in a distributed ledger, such as, but not limited to, the blockchain. The VV server 130 may store the authentication level in the distributed ledger so that it may be accessed by different users and so that the information may be immutable and frozen in time. In some further embodiments, the VV server 130 signs the authentication level, such as with the corresponding user's public key.

Further examples of multifactor authentication includes, but is not limited to, camera and fingerprint login to devices know to associate with the first user 105, fingerprint sensors in keys or mouse scroll wheel, continuous biometric information (e.g., continuous heartbeat from smartwatch), GPS locations of devices 110, 115, and/or 120, media access control addresses for the devices 110, 115, and 120, devices 110, 115, and 120 in concurrent locations, signed delivery with assurance that the content has not been copied or changed from the source and directly delivered to destination, AI (artificial intelligence) of information for further confirmation of person, state of mind, etc. An example of state of mind or behavior includes still having the smartphone being in Bluetooth range of the laptop or wearable.

In further embodiments, devices 110, 115, and 120 that are nearby each other may be in range of each other for detecting each other via Bluetooth. In additional embodiments, one or more of the devices 110, 115, and 120 may initiate a Bluetooth confirmation handshake to increase/improve/change authentication level for the corresponding user 105.

In some embodiments, the content is stored on a third-party server 160 to allow access to individuals with the appropriate authentication levels.

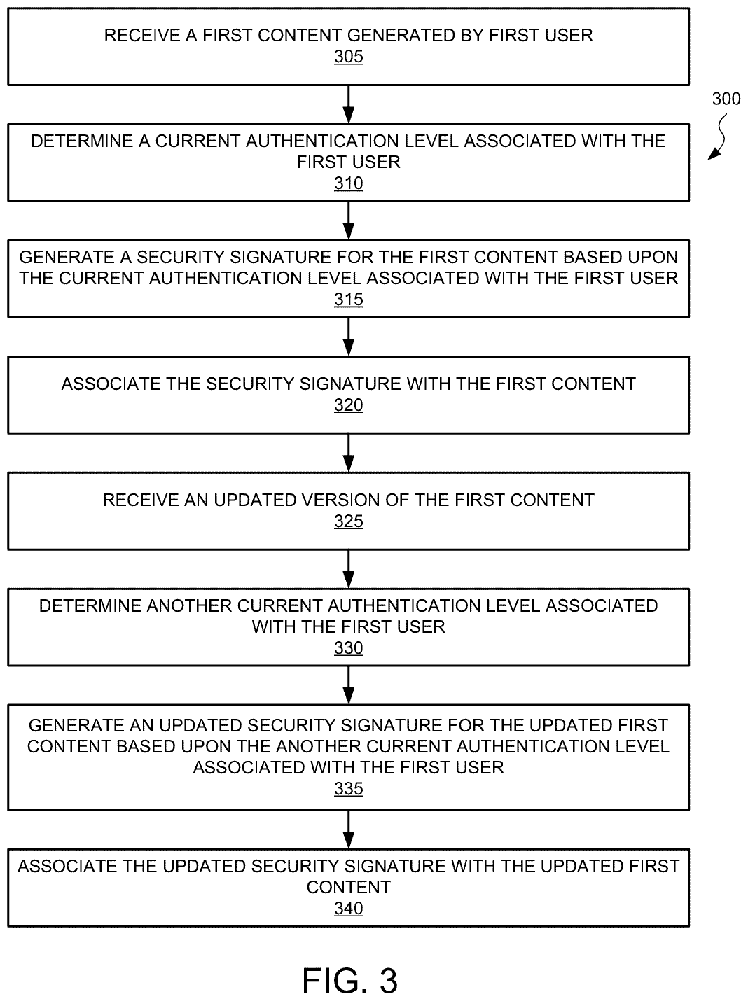

FIG. 3 illustrates an exemplary process 300 for authenticating content using the VV system 100 (shown in FIG. 1). In the example embodiment, the steps of process 300 are performed by the VV server 130 (shown in FIG. 1). In the example embodiment, the steps of process 300 begin after the corresponding user (e.g., the first user 105 (shown in FIG. 1)) has been authenticated, such as through the steps of process 200 (shown in FIG. 2).

In the example embodiment, the VV server 130 receives 305 a first content generated by the first user 105. The first content includes, but is not limited to, images, video, text, documents, spreadsheets, messages, email, and/or any other content desired. In some embodiments, the first user 105 creates the first content via an application or computer program, where the application or computer program is in communication with the VV server 130. In some embodiments, the application or computer program is collecting and providing authentication data to the VV server 130 for the VV server 130 to determine 220 (shown in FIG. 2) the updated authentication level.

In the example embodiment, the VV server 130 determines 310 a current authentication level associated with the first user 105. The current authentication level is the current updated authentication level for the first user 105. In the example embodiment, the current authentication level is provided 225 by process 200.

In the example embodiment, the VV server 130 generates 315 a security signature for the first content based upon the current authentication level associated with the first user 105. In some embodiments, the security signature is a hash of the authentication level, identifying information for the first user 105, the first content, time/date information, device information, and/or any other information desired. The VV server 130 associates 320 the security signature with the first content. In some embodiments, the security signature is appended to the first content as metadata and encrypted. In additional embodiment, the security signature is provided to a third party for confirmation, such as the distributed ledger. In this embodiment, the security signature is encrypted, such as with a public key of the first user 105.

In the example embodiment, the VV server 130 receives 325 and updated version of the first content. In some embodiments, the VV server 130 checks and stores the authentication level of the first user 105 while they are creating the first content on a periodic basis. In these embodiments, the VV server 130 is continually verifying the authentication of the first user 105 as they create the first content. The VV server 130 determines 330 another current authentication level associated with the first user 105, where the another current authentication level is based on the authentication level for the first user 105 at that point in time. Then the VV server 130 generates 335 an updated security signature for the updated first content based upon the another current authentication level for the first user 105. And the VV server 130 associates 340 the updated security signature with the updated first content. In the example embodiment, each element of the first content has an associated security signature based upon an authentication level.

In further embodiments, the authentication level is stored as a security score, where the security score for each element or point in time is stored with the first content, such as in the metadata. Furthermore, the authentication level or security score is stored in an encrypted format.

In the example embodiment, the first content is locked and encrypted to prevent access by unauthorized users. Furthermore, since the hash for the security signatures is of the entire content with its authentication level, this allows for the detection of tampering with the first content. The security signature also shows a history of the changes to the first content and who is associated with these changes.

In further embodiments, the VV server 130 confirms the authentication level of the first content, but reviewing and validating the security signatures of the content. This includes checking the corresponding hashes to confirm that the first content has not be tampered with.

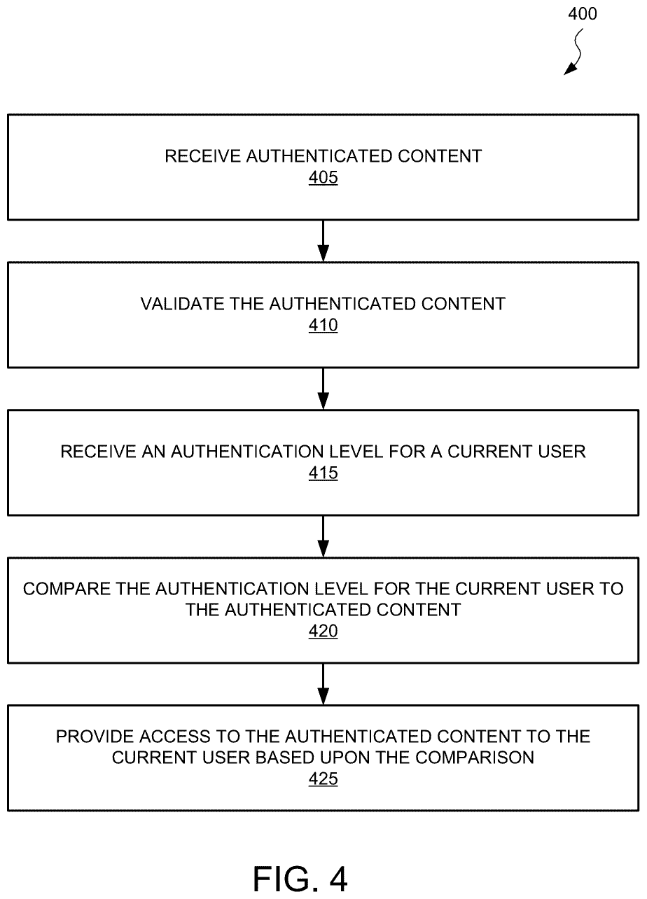

FIG. 4 illustrates an exemplary process 400 for verifying a user to access content using the VV system 100 (shown in FIG. 1). In the example embodiment, the steps of process 400 are performed by the VV server 130 (shown in FIG. 1). In the example embodiment, the steps of process 400 begin after the corresponding user (e.g., the second user 135 (shown in FIG. 1)) has been authenticated, such as through the steps of process 200 (shown in FIG. 2) and after content has been authenticated.

In the example embodiment, the VV server 130 receives 405 authenticated content. In some embodiments, the VV server 130 retrieves the authenticated content at the request of the second user 135 (shown in FIG. 1).

In the example embodiment, the VV server 130 validates 410 the authenticated content. In these embodiments, the VV server 130 retrieves the authentication information, such as confirmation of the security signature where it is being stored by a third-party server 160 (shown in FIG. 1), such as in a distributed ledger. The VV server 130 compares the security signature provided by the authenticated content with the security signature from the third-party server 160. If the security signatures match, then the VV server 130 proceeds. In some embodiments, the VV server 130 retrieves authentication information about the creator of the authenticated content and validates the creator in view of the authenticated content.

In the example embodiment, the VV server 130 receives 415 an authentication level for a current user, such as the second user 135 that requested access to the authenticated content. In the example embodiment, the authentication level is the updated authentication level provided 225 (shown in FIG. 2) by process 200.

In the example embodiment, the VV server 130 compares 420 the authentication level for the current user to the authenticated content. In the example embodiment, the VV server 130 provides 425 access to the authenticated content to the current user based upon the comparison. In one example, the first content requires two out of five factors to be authenticated before providing access to the first content. The VV server 130 confirms that the second user 135 has authenticated at least two factors and if so, then provides access to the first content. In another example, the first content requires two factors, but one of them is required to be a specific factor. The VV server 130 only provides access to the first content if the user has at least two factors, with one of them being the required factors. In some of these embodiments, the VV server 130 requests to the user that the user complete the required authentication factor to be allowed to access the first content.

In some situations, the authenticated content has a required authentication level for access to the authenticated content. In some other embodiments, a user has defined required authentication levels for content that the user will access. In all of these embodiments, the VV server 130 determines if the two sets of authentication levels allow the authenticated content to be provided to the user. In some embodiments, the VV server 130 asks the user to provide additional authentication data to be allowed to access the authentication content. In other embodiments, the VV server 130 asks the user to confirm if they want to access the authenticated content, if the content's authentication level is below one or more predetermined thresholds set by the user.

In some embodiments, the VV server 130 may display an indicator of the authentication level to the user before providing 4725 access to the authenticated content. In some embodiments, the VV server 130 provides a list of available content to the current user including the corresponding authentication levels. In these embodiments, the VV server 130 may filter out or grey out content that does not match the authentication level of the current user. For example, the VV server 130 displays a list showing content that does not have sufficient authentication levels for the user as greyed out, while filtering out (hiding) content that the user does not have a sufficient authentication level for.

In some embodiments, the VV server 130 adds a record of the current user's access of the authenticated content, such as through a security signature of the user's identity and authentication level that is added to the authenticated content and/or a third-party server 160, such as a distributed ledger.

In some embodiments, the VV server 130 is embedded in an application, computer program, and/or web-based application to authenticate users before providing access to any of the content of the application, computer program, and/or web-based application.

In some further embodiments, the authentication level includes an identification key with a public key to allow users to automatically get verification of a message or other content by detecting the identification key in the text and the public key that follows it. The VV server 130 then can verify and validate that the message is legitimate and from the advertised party. In some embodiments, this may be done with pairs of key exchanges.

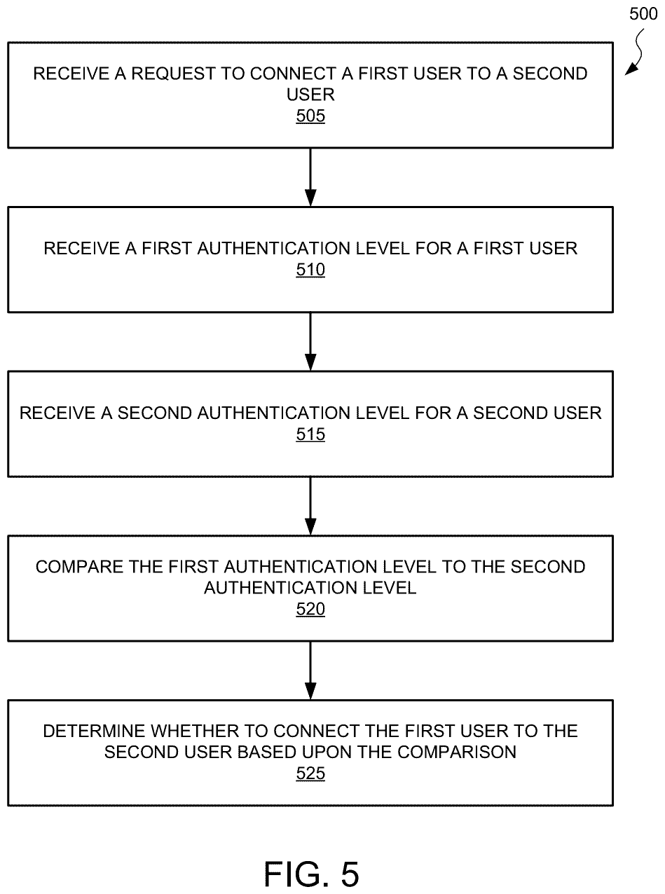

FIG. 5 illustrates an exemplary process 500 for verifying and validating users to connect to each other using the VV system 100 (shown in FIG. 1. In the example embodiment, the steps of process 500 are performed by the VV server 130 (shown in FIG. 1). In the example embodiment, the steps of process 500 begin after the corresponding user (e.g., the first user 105 and the second user 135 (both shown in FIG. 1)) has been authenticated, such as through the steps of process 200 (shown in FIG. 2).

In the example embodiment, process 500 is used when one or more users 105 and 135 connect to each other in real-time, such as via a video conference. In process 500, each user 105 and 135 is continually authenticated by process 200 and their respective authentication levels are shared with to the computer devices of the other users 105 and 135. The VV server 130 tracks and shares the respective authentication levels. The VV server 130 also monitors the stored preferences of the different users 105 and 135 to determine if they should have access to the other users and/or their content. If the first user 105 has a lower authentication level that the minimum authentication level allowed by the second user 135, the second user 135 will have to decide whether or not to override their preferences and connect to the first user 105. Of the second user 135 can have the VV server 130 request one or more additional authentications by the first user 105 before connecting.

In a multi-party interaction, the VV server 130 checks the preferences and authentication level for each user 105 or 135 to determine if they can access the interaction. Each user must pass the required authentication level of all of the other users in the interaction. Or must have the users approve the others accessing the interaction.

With the continuous authentication, the VV server 130 might determine that a user's authentication level is no longer sufficient to connect to the interaction. In some embodiments, the VV server 130 drops the corresponding user from the call. In other embodiments, the VV server 130 asks the user to perform an active authentication to raise their authentication level. In further embodiments, the VV server 130 asks the other users to approve having the user with the insufficient authentication level. For example, on a video call, if someone walks away from the camera and facial recognition is a required factor for the authentication level for the conversation or a party on the conversation, the feed to and from the user who walked away can be stopped. This essentially puts them on hold or forces them to drop and reestablish. Likewise, user(s) whose policy is violated by that user walking away, even though the communication policy may not be as strict, may block their send and-or receive from that user. Users may drop the communication as they please as well.

In the example embodiment, the VV server 130 receives 505 a request to connect a first user 105 to a second user 135. The request to connect is for a real-time connection, such as for a video call, an audio call, or online conference. Each of the first user 105 and the second user 135 have logged on to one or more devices, such as computer devices 110 and 140 and/or mobile devices 115. Furthermore, each of the first user 105 and the second user 135 have one or more connection policies describing the different authentication levels that they approve to connect with to other people, to programs, and/or to content.

In the example embodiment, the VV server 130 receives 510 a first authentication level for the first user 105. In the example embodiment, the VV server 130 receives 515 a second authentication level for the second user 135. Both the first authentication level and the second authentication level are updated authentication levels, such as those provided 225 in real-time by process 200.

In the example embodiment, the VV server 130 compares 520 the first authentication level to the second authentication level. In the example embodiment, the VV server 130 compares the first authentication level to the connection policy of the second user 135. The VV server 130 also compares the second authentication level to the connection policy of the first user 105.

In the example embodiment, the VV server 130 determines 252 whether to connect the first user 105 to the second user 135 based upon the comparison. If both authentication levels are sufficient for the different connection policies, then the VV server 130 connects the first user 105 and the second user 135. If there are more users, then the VV server 130 performs the comparisons for those users as well.

In further embodiments, users who join later start at the beginning of this process, and are accepted or rejected by others as described above.

In further embodiments, a user interface may display an indicator of the authentication level for each connected user. This indicator may be continually updated with data from process 200.

In further embodiments, if a user 105 or 135 in the interaction shares content, such as a document, the content might only be shared with those of an appropriate authentication level. This is similar to process 400 (shown in FIG. 4).

### MACHINE LEARNING AND OTHER MATTERS

In some embodiments, VV server 130 is configured to implement machine learning, such that VV server 130 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms.

In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In certain embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features. Such information may include, for example, information associated with a plurality of images of a plurality of different objects, items, and/or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, and servers. Furthermore, these include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The aspects described herein may be implemented as part of one or more computer components such as a client device and/or one or more back-end components, such as a cloud service server, for example. Furthermore, the aspects described herein may be implemented as part of computer network architecture and/or a cognitive computing architecture that facilitates communications between various other devices and/or components. Thus, the aspects described herein address and solve issues of a technical nature that are necessarily rooted in computer technology.

Furthermore, the embodiments described herein improve upon existing technologies, and improve the functionality of computers, by improving the security of provisioning devices and preventing their access to the network before they are fully provisioned. The present embodiments improve the speed, efficiency, and accuracy in which such calculations and processor analysis may be performed. Due to these improvements, the aspects address computer-related issues regarding efficiency over conventional techniques. Thus, the aspects also address computer related issues that are related to computer security, for example.

Accordingly, the innovative systems and methods described herein are of particular value within the realm of secure Internet communications. The present embodiments enable more reliable security during the device provisioning process, but without compromising data and speed. Furthermore, according to the disclosed techniques, user computer devices are better able to ensure the security of websites and other connected devices, and thereby protecting computer devices from malicious actors.

Exemplary embodiments of systems and methods for provisioning devices are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for ongoing multifactor authentication, the system comprising a computer device comprising at least one processor in communication with at least one memory device, wherein the at least one processor is programmed to:
instruct a computer device to conduct a multifactor authentication of a user;
calculate an authentication level for the user based upon the multifactor authentication of the user;
continually monitor one or more actions of the user to determine additional authentication data;
update the authentication level for the user based upon the additional authentication data;
receive a request from the user to access a first content;
access an authentication profile for the first content;
compare the authentication profile to the updated authentication level for the user; and
determine whether to grant access to the first content based upon the comparison.

2. The system of claim 1, wherein the at least one processor is further programmed to:
retrieve an authentication level associated with the first content; and
validate the first content based upon the authentication level associated with the first content.

3. The system of claim 1, wherein the first content includes a security signature for a creator of the first content.

4. The system of claim 3, wherein the security signature includes an identifier for the creator of the first content and an authentication level for the creator of the first content during creation of the first content.

5. The system of claim 3, wherein the security signature includes a hash of the first content and the authentication level for the creator of the first content.

6. The system of claim 5, wherein the at least one processor is further programmed to:
retrieve a copy of the hash from a third-party server; and
compare the copy of the hash from the third-party server to the hash from the security signature to validate the first content.

7. The system of claim 1, wherein the first content is encrypted.

8. The system of claim 1, wherein the first content is locked from being changed.

9. The system of claim 1, wherein the authentication profile includes a required authentication level to be able to access the first content.

10. The system of claim 9, wherein the at least one processor is further programmed to:
determine that the updated authentication level for the user is insufficient for the authentication profile; and
request one or more additional authentication activities from the user to access the first content.

11. The system of claim 1, wherein the at least one processor is further programmed to:
receive a listing of a plurality of content items, wherein each content item includes a required authentication level to access;
compare the updated authentication level of the user the plurality of required authentication levels to access; and
filter and display at least a portion of the plurality of content items based upon the comparison.

12. The system of claim 11, wherein the at least one processor is further programmed to prevent display of content items of the plurality of content items that the updated authentication level is insufficient to access.

13. The system of claim 11, wherein the at least one processor is further programmed to display an indicator of the required authentication level for each displayed content item listing.

14. The system of claim 11, wherein the request from the user to access a first content is from a user selection of the first content from the plurality of content items.

15. A system for ongoing multifactor authentication, the system comprising a computer device comprising at least one processor in communication with at least one memory device, wherein the at least one processor is programmed to:
instruct a computer device to conduct a multifactor authentication of a user;
calculate an authentication level for the user based upon the multifactor authentication of the user;
continually monitor one or more actions of the user to determine additional authentication data;
update the authentication level for the user based upon the additional authentication data;
receive a first content item from the user;
generate a security signature for the first content item based upon the updated authentication level for the user; and
add the security signature to the first content item.

16. The system of claim 15, wherein the security signature includes a hash of the first content item and the authentication level for the user.

17. The system of claim 16, wherein the at least one processor is further programmed to store a copy of the hash with a third-party server to be used to validate the first content item.

18. The system of claim 15, wherein the at least one processor is further programmed to store an authentication profile with the first content item that includes a required authentication level to be able to access the first content.

19. The system of claim 15, wherein the first content item is encrypted.

20. The system of claim 15, wherein the first content item is locked from being changed.
